(19) United States
(12) Patent Application Publication
(10) Pub. No.: US 2024/0256960 A1
(43) Pub. Date: Aug. 1, 2024

(54) SYSTEMS AND METHODS FOR SEMI-SUPERVISED ANOMALY DETECTION THROUGH ENSEMBLE STACKING

(71) Applicant: Walmart Apollo, LLC, Bentonville, AR (US)

(72) Inventors: Chuying Ma, Sunnyvale, CA (US); Jingru Zhou, San Jose, CA (US)

(21) Appl. No.: 18/417,363

(22) Filed: Jan. 19, 2024

Related U.S. Application Data
(60) Provisional application No. 63/442,353, filed on Jan. 31, 2023.

(51) Int. Cl. G06N 20/00

(52) U.S. Cl. CPC G06N 20/00

(57) ABSTRACT

Systems and methods of generating and deploying a final anomaly classification model are disclosed. A training dataset including data representative of a plurality of interactions is obtained and a plurality of anomaly detection models are generated. At least one of the plurality of anomaly detection models is generated by an unsupervised training process. A unified anomaly score is generated by combining outputs of a subset of the plurality of anomaly detection models and an augmented training dataset is generated by labeling at least one of the interactions in the plurality of interactions based on the unified anomaly score. The anomaly classification model is generated by applying a supervised training process including the augmented training dataset.

### CROSS-REFERENCE TO RELATED APPLICATIONS

This application claims benefit to U.S. Provisional Appl. No. 63/442,353, filed 31 Jan. 2023, entitled System and Method for Semi-Supervised Anomaly Detection Through Ensemble Stacking, the disclosure of which is incorporated herein by reference in its entirety.

### TECHNICAL FIELD

This application relates generally to automated anomaly detection, and more particularly, to anomaly detection using unified anomaly detection models.

### BACKGROUND

Traditional anomaly detection systems are generated using a predetermined set of assumptions to detect a specific type of anomaly. Current systems are capable of detecting point, contextual, or collective anomalies. However, current systems are developed for specific anomaly types, based on the specific set of assumptions, and therefore present drawbacks when presented with new or changing anomalous patterns.

Traditional classification systems using supervised learning models also suffer from a lack of training data, as anomalous patterns are typically rare when compared to non-anomalous or expected patterns. Thus, although large datasets can exist for certain domains, the lack of anomalous patterns within the datasets makes training models difficult.

### SUMMARY

In various embodiments, a system is disclosed. The system includes a non-transitory memory and a processor communicatively coupled to the non-transitory memory. The processor is configured to read a set of instructions to obtain, from the non-transitory memory, a training dataset including data representative of a plurality of interactions and generate a plurality of individual anomaly detection models. At least one of the plurality of individual anomaly detection models is generated by an unsupervised training process. The processor is further configured to generate a unified anomaly score by combining outputs of a subset of the plurality of individual anomaly detection models, generate an augmented training dataset by labeling at least one of the interactions in the plurality of interactions based on the unified anomaly score, and generate an anomaly classification model by applying a supervised training process including the augmented training dataset.

In various embodiments, a computer-implemented method is disclosed. The method includes the steps of obtaining a training dataset including data representative of a plurality of interactions and generating a plurality of individual anomaly detection models. At least one of the plurality of individual anomaly detection models is generated by an unsupervised training process. The method further includes the steps of generating a unified anomaly score by combining outputs of a subset of the plurality of individual anomaly detection models, generating an augmented training dataset by labeling at least one of the interactions in the plurality of interactions based on the unified anomaly score, and generating an anomaly classification model by applying a supervised training process including the augmented training dataset.

In various embodiments, a non-transitory computer readable medium having instructions stored thereon is disclosed. The instructions, when executed by one or more processors, cause one or more devices to perform operations including obtaining a training dataset including data representative of a plurality of interactions and generating a plurality of individual anomaly detection models. At least one of the plurality of individual anomaly detection models is generated by an unsupervised training process. The instructions further cause the one or more devices to perform operations including generating a unified anomaly score by combining outputs of a subset of the plurality of individual anomaly detection models, generating an augmented training dataset by labeling at least one of the interactions in the plurality of interactions based on the unified anomaly score, and generating an anomaly classification model by applying a supervised training process including the augmented training dataset.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a computer system configured to implement one or more processes, in accordance with some embodiments;

FIG. 2 illustrates a network environment configured to provide anomaly detection and training of anomaly classification models, in accordance with some embodiments;

FIG. 3 illustrates an artificial neural network, in accordance with some embodiments;

FIG. 4 illustrates a tree-based model, in accordance with some embodiments;

FIG. 5 illustrates a deep neural network, in accordance with some embodiments;

FIG. 6 illustrates an autoencoder network, in accordance with some embodiments;

FIG. 7 is a flowchart illustrating a method of classifying an interaction using a trained final anomaly classification model, in accordance with some embodiments;

FIG. 8 illustrates a process flow of various portions of the method of classifying an interaction, in accordance with some embodiments;

FIG. 9 illustrates a method of generating a trained final anomaly detection method, in accordance with some embodiments; and

FIG. 10 illustrates a process flow including various steps of the method of generating a trained final anomaly detection method, in accordance with some embodiments.

### DETAILED DESCRIPTION

This description of the exemplary embodiments is intended to be read in connection with the accompanying drawings, which are to be considered part of the entire written description. The drawing figures are not necessarily to scale and certain features of the invention may be shown exaggerated in scale or in somewhat schematic form in the interest of clarity and conciseness. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein can be assigned to the other claimed objects and vice versa. In other words, claims for the systems can be improved with features described or claimed in the context of the methods. In this case, the functional features of the method are embodied by objective units of the systems.

Furthermore, in the following, various embodiments are described with respect to methods and systems for anomaly detection using unified anomaly detection models and an anomaly classification model. In various embodiments, a plurality of anomaly detection models having various frameworks and parameters are generated. The plurality of anomaly detection models are evaluated and a set of models is selected from the plurality of models based on the evaluation. The set of models (e.g., the output of each model in the set of models) are combined to generate a unified anomaly score, which can be used to evaluate the anomalous nature of an input. In some embodiments, the set of models is combined by an ensemble stacking process.

The disclosed systems and methods provide a generalized, systematic, and flexible anomaly detection architecture. Disclosed systems and methods can include combinations of any suitable trained models that are fit together using an ensemble stacking process to generate a unified anomaly detection score. Any suitable anomaly, such as a data anomaly, behavioral anomaly, fraudulent transaction, etc., can be detected using the disclosed systems and methods. In some embodiments, a generated unified anomaly detection score is used to augment (e.g., enrich) existing data sets, such as labels, to train additional anomaly classification models that are deployed for anomaly detection.

In some embodiments, systems, and methods for anomaly detection includes two or more trained anomaly detection models that are combined by an ensemble stacking process to generate a unified anomaly detection score. The ensemble stacking process is configured to generate, evaluate, and combine two or more trained anomaly detection models using, in part, unlabeled data. The ensemble stacking process can include any suitable type of trained detection model, such as, for example, one or more trained gaussian models, one or more trained isolation forest models, one or more trained autoencoders, one or more other trained detection models, and/or any other suitable trained machine learning models.

In general, a trained function mimics cognitive functions that humans associate with other human minds. In particular, by training based on training data the trained function is able to adapt to new circumstances and to detect and extrapolate patterns.

In general, parameters of a trained function can be adapted by means of training. In particular, a combination of supervised training, semi-supervised training, unsupervised training, reinforcement learning and/or active learning can be used. Furthermore, representation learning (an alternative term is “feature learning”) can be used. In particular, the parameters of the trained functions can be adapted iteratively by several steps of training.

In particular, a trained function can comprise a neural network, a support vector machine, a decision tree and/or a Bayesian network, and/or the trained function can be based on k-means clustering, Qlearning, genetic algorithms and/or association rules. In particular, a neural network can be a deep neural network, a convolutional neural network, or a convolutional deep neural network. Furthermore, a neural network can be an adversarial network, a deep adversarial network and/or a generative adversarial network.

In various embodiments, two or more neural networks which are trained (e.g., configured or adapted) to perform anomaly detection, are disclosed. A neural network trained to perform anomaly detection may be referred to as a trained detection network and/or a trained detection model. The trained detection models can be configured to receive an input, such as a set of data representative of a pattern of behavior (e.g., an interaction, a transaction, etc.) and determine if the pattern of behavior is anomalous (e.g., outside predetermined bounds, fraudulent, etc.).

In some embodiments, two or more neural networks configured to perform anomaly detection are combined into a unified anomaly detection model by an ensemble stacking process. The ensemble stacking process can combine the two or more trained detection models (e.g., combine outputs of the trained detection models) to generate a unified anomaly detection score. The unified anomaly detection score can be used to classify a pattern of behavior as anomalous or non-anomalous (e.g., fraudulent or authentic, approved or denied, etc.).

In some embodiments, labeled training data is generated based on the unified anomaly detection score and is used to train an anomaly classification model using a supervised training process. For example, in some embodiments, a plurality of trained anomaly detection models are trained using one or more unsupervised training processes and unlabeled training data containing a plurality of behavior patterns. The plurality of trained anomaly detection models are combined using an ensemble stacking process to generate a unified anomaly detection score. Each of the behavior patterns within the unlabeled training dataset are labeled as either anomalous or non-anomalous to generate a labeled training data set. A supervised training process is then executed to generate a trained anomaly classification model which is deployed for anomaly detection within a computer environment.

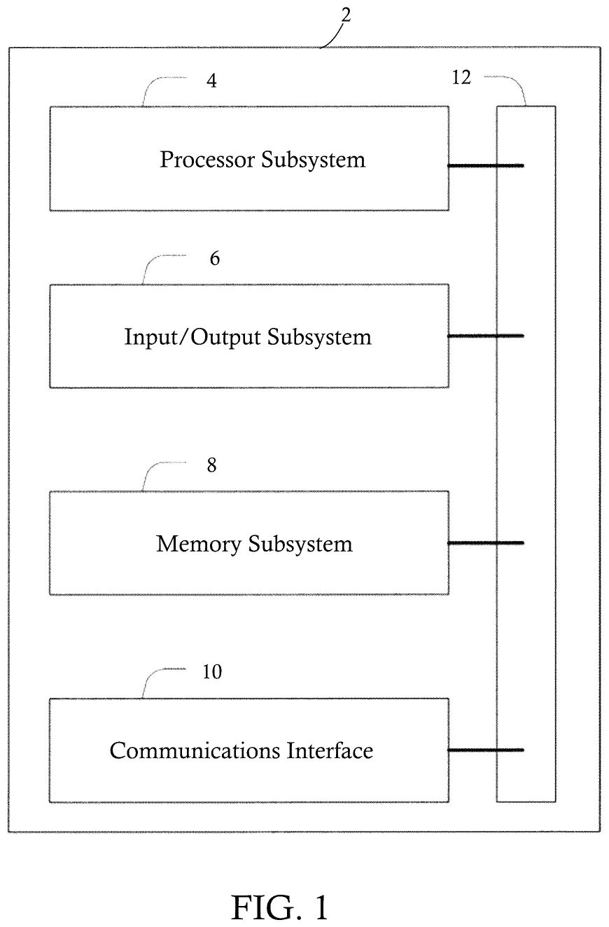

FIG. 1 illustrates a computer system configured to implement one or more processes, in accordance with some embodiments. The system 2 is a representative device and can include a processor subsystem 4, an input/output subsystem 6, a memory subsystem 8, a communications interface 10, and a system bus 12. In some embodiments, one or more than one of the system 2 components can be combined or omitted such as, for example, not including an input/output subsystem 6. In some embodiments, the system 2 can include other components not combined or comprised in those shown in FIG. 1. For example, the system 2 can also include, for example, a power subsystem. In other embodiments, the system 2 can include several instances of the components shown in FIG. 1. For example, the system 2 can include multiple memory subsystems 8. For the sake of conciseness and clarity, and not limitation, one of each of the components is shown in FIG. 1.

The processor subsystem 4 can include any processing circuitry operative to control the operations and performance of the system 2. In various aspects, the processor subsystem 4 can be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also can be implemented by a controller, a microcontroller, an application specific integrated circuit (ASIC), a field programmable gate array (FPGA), a programmable logic device (PLD), and so forth.

In various aspects, the processor subsystem 4 can be arranged to run an operating system (OS) and various applications. Examples of an OS comprise, for example, operating systems generally known under the trade name of Apple OS, Microsoft Windows OS, Android OS, Linux OS, and any other proprietary or open-source OS. Examples of applications comprise, for example, network applications, local applications, data input/output applications, user interaction applications, etc.

In some embodiments, the system 2 can include a system bus 12 that couples various system components including the processor subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 can include any suitable mechanism or component to enable a user to provide input to system 2 and the system 2 to provide output to the user. For example, the input/output subsystem 6 can include any suitable input mechanism, including but not limited to, a button, keypad, keyboard, click wheel, touch screen, motion sensor, microphone, camera, etc.

In some embodiments, the input/output subsystem 6 can include a visual peripheral output device for providing a display visible to the user. For example, the visual peripheral output device can include a screen such as, for example, a Liquid Crystal Display (LCD) screen. As another example, the visual peripheral output device can include a movable display or projecting system for providing a display of content on a surface remote from the system 2. In some embodiments, the visual peripheral output device can include a coder/decoder, also known as Codecs, to convert digital media data into analog signals. For example, the visual peripheral output device can include video Codecs, audio Codecs, or any other suitable type of Codec.

The visual peripheral output device can include display drivers, circuitry for driving display drivers, or both. The visual peripheral output device can be operative to display content under the direction of the processor subsystem 4. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 can include any suitable hardware, software, or combination of hardware and software that is capable of coupling the system 2 to one or more networks and/or additional devices. The communications interface 10 can be arranged to operate with any suitable technique for controlling information signals using a desired set of communications protocols, services, or operating procedures. The communications interface 10 can include the appropriate physical connectors to connect with a corresponding communications medium, whether wired or wireless.

Vehicles of communication comprise a network. In various aspects, the network can include local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules can communicate in accordance with a number of wired protocols. Examples of wired protocols can include Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 can include one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 can include a wireless interface comprising one or more antennas, transmitters, receivers, transceivers, amplifiers, filters, control logic, and so forth.

In various aspects, the communications interface 10 can provide data communications functionality in accordance with a number of protocols. Examples of protocols can include various wireless local area network (WLAN) protocols, including the Institute of Electrical and Electronics Engineers (IEEE) 802.xx series of protocols, such as IEEE 802.11a/b/g/n/ac/ax/be, IEEE 802.16, IEEE 802.20, and so forth. Other examples of wireless protocols can include various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, the Wi-Fi series of protocols including Wi-Fi Legacy, Wi-Fi 1/2/3/4/5/6/6E, and so forth. Further examples of wireless protocols can include wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols can include near-field communication techniques and protocols, such as electromagnetic induction (EMI) techniques. An example of EMI techniques can include passive or active radio-frequency identification (RFID) protocols and devices. Other suitable protocols can include Ultra-Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 can include any machine-readable or computer-readable media capable of storing data, including both volatile/non-volatile memory and removable/non-removable memory. The memory subsystem 8 can include at least one non-volatile memory unit. The non-volatile memory unit is capable of storing one or more software programs. The software programs can contain, for example, applications, user data, device data, and/or configuration data, or combinations therefore, to name only a few. The software programs can contain instructions executable by the various components of the system 2.

In various aspects, the memory subsystem 8 can include any machine-readable or computer-readable media capable of storing data, including both volatile/non-volatile memory and removable/non-removable memory. For example, memory can include read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 can contain an instruction set, in the form of a file for executing various methods, such as methods for training, combining, and/or deploying anomaly detection and/or classification models, as described herein. The instruction set can be stored in any acceptable form of machine-readable instructions, including source code or various appropriate programming languages. Some examples of programming languages that can be used to store the instruction set comprise, but are not limited to: Java, C, C++, C #, Python, Objective-C, Visual Basic, or .NET programming. In some embodiments a compiler or interpreter is comprised to convert the instruction set into machine executable code for execution by the processor subsystem 4.

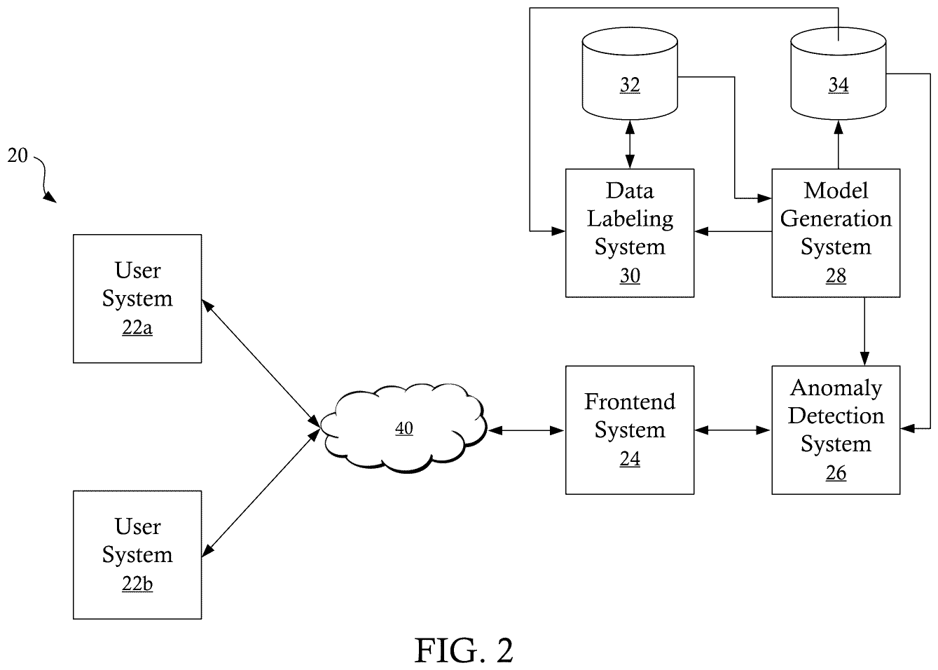

FIG. 2 illustrates a network environment 20 configured to provide anomaly detection and training of anomaly detection and/or classification models, in accordance with some embodiments. The network environment 20 includes a plurality of systems configured to communicate over one or more network channels, illustrated as network cloud 40. For example, in various embodiments, the network environment 20 can include, but is not limited to, one or more interaction systems 22a, 22b, a frontend system 24, an anomaly detection system 26, a model training system 28, a data labeling system 30, an interaction database 32, and a model database 34. Each of the interaction systems 22a, 22b, the frontend system 24, the anomaly detection system 26, the model training system 28, and/or the data labeling system 30 can include a system as described above with respect to FIG. 1, a portion of a system as described above with respect to FIG. 1, and/or any other suitable system.

Although embodiments are illustrated including discrete systems, it will be appreciated that one or more of the illustrated systems can be combined into a single system configured to implement the functionality, services, and/or engines of each of the combined systems. For example, in some embodiments, a frontend system 24, an anomaly detection system 26, and/or a model training system 28 can be combined into a single physical and/or logical system containing the software and/or hardware elements of each of the individual systems. It will also be appreciated each of the illustrated systems can be replicated and/or split into multiple systems containing similar hardware and/or software and/or distributed hardware and/or software elements. Further, additional systems not illustrated in FIG. 2 can be included within the network environment.

In some embodiments, each of the interaction systems 22a, 22b are configured to generate data related to interactions including the interaction system 22a, 22b. For example, the interaction systems 22a, 22b can include point-of-sale systems configured to generate data representative of transactions performed via the interaction systems 22a, 22b, such as purchase transactions, return transactions, exchange transactions, etc. The interactions performed via the interaction system 22a, 22b can include online interactions (e.g., interactions with network interfaces and/or network systems), brick-and-mortar interactions (e.g., transactions performed at a brick-and-mortar retail establishment), and/or any other suitable interactions.

In some embodiments, each of the interaction systems 22a, 22b are configured to interact with and/or otherwise provide data to the frontend system 24. For example, in some embodiments, the interaction systems 22a, 22b include systems configured to generate records of customer interactions with one or more retail venues, such as, for example, brick-and-mortar purchases, online purchases, and/or otherwise providing customer records or purchase records including attributes of various products or services. In some embodiments, the records of customer interactions include sales data, return data, and/or any other suitable interaction data. The frontend system 24 can be configured to receive, store, and/or process data representative of interactions received from each of the interaction systems 22a, 22b.

In some embodiments, the interaction systems 22a, 22b are configured to provide user interfaces and/or access a network interface that allows interactions with the frontend system 24. For example, in some embodiments, the frontend system 24 includes an interface server, such as a web server, configured to provide a networked interface that allows online interactions, such as purchase interactions, service interactions, return interactions, etc. The frontend system 24 can be configured to collect data related to online interactions and/or receive data from the interaction systems 22a, 22b related to the online interactions.

In some embodiments, the anomaly detection system 26 is configured to implement one or more processes for identifying anomalies within the interaction data received and/or generated by the frontend system 24. For example, an anomaly detection engine can be configured to detect one or more anomalies using an anomaly classification model. The anomaly classification model can be generated by the model training system 28. The anomaly classification model is configured to receive a set of input features related to an interaction and classify the interaction as anomalous or non-anomalous. For example, the anomaly classification model can be configured to receive input features related to a user or customer initiating the interaction, features related to the interaction itself, and/or any other suitable features.

The anomaly classification model can include a supervised classification model trained using a labeled training set to identify anomalies based on sets of input features. In some embodiments, the interaction data can include data related to retail interactions, such as purchase or return interactions, and the anomaly detection system 26 is configured to detect one or more suspicious or fraudulent returns included in the interaction data. The interaction data may include records associated with each of the interaction systems 22a, 22b and/or records associated with other systems or interactions. In some embodiments, records may be stored in a database, such as interaction database 32. In the context of an e-commerce environment, each of the records can include purchase histories including attributes associated with a customer and/or with each of the purchased products. Although certain embodiments are discussed herein in the context of an e-commerce environment, it will be appreciated that the disclosed systems and methods can be used for anomaly detection within any suitable interaction data.

As discussed in greater detail below, an anomaly classification engine can be configured to implement one or more trained anomaly classification models configured to detect suspicious or fraudulent retail interactions, such as fraudulent returns. The anomaly classification model can include a supervised classification model trained using a labeled training set to identify anomalies based on sets of input features. The anomaly detection engine can be configured to flag or otherwise identify target transactions that falls outside an acceptable conformity rate as fraudulent.

In some embodiments, the model training system 28 is configured to generate (e.g., train) an anomaly classification model using a supervised training process. For example, a supervised model training engine can be configured to apply a supervised training process to an untrained model based on a set of labeled training data. The labeled training data includes data representative of a plurality of transactions with each transaction being labeled, e.g., identified, as one of an anomalous transaction or a benign transaction. As discussed in greater detail below, labeled training data can be generated by an ensemble anomaly classification model. An anomaly classification model can be deployed directly to an anomaly detection system 26 and/or can be stored in a model store, such as model database 34, for retrieval and deployment by one or more additional systems.

In some embodiments, a data labeling system 30 is configured to generate labeled data based on a unified anomaly detection score. For example, a data labeling engine can be configured to implement an ensemble anomaly detection model to label interaction data as either anomalous or benign (e.g., non-anomalous). The data labeling engine can be configured to receive interaction data from any suitable system, such as, for example, the interaction systems 22a, 22b, the frontend system 24, and/or any suitable database, such as interaction database 32. In some embodiments, the unlabeled interaction data includes data used to train at least one of the individual anomaly detection models included in the ensemble anomaly detection model.

In some embodiments, the model training system 28 is configured to generate a plurality of individual anomaly detection models. For example, the model training system 28 can be configured to generate individual anomaly detection models having various frameworks, inputs, and/or model parameters. The model training system 28 can be configured to generate any suitable anomaly detection models, such as Gaussian models, isolation forest models, autoencoder models, other detection models, etc. Each of the individual anomaly detection models can be generated using semi-labeled or unlabeled data and can be configured to generate a prediction or classification score.

In some embodiments, the model training system 28 is configured to generate an ensemble anomaly detection model using an ensemble stacking process. For example, the model training system 28 can be configured to combine the individual anomaly detection models (e.g., combine the outputs of the models) using an ensemble stacking process to generate a unified anomaly detection score. The unified anomaly detection score can be based on any number of combined individual anomaly detection models.

In various embodiments, the system or components thereof can comprise or include various modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the examples herein.

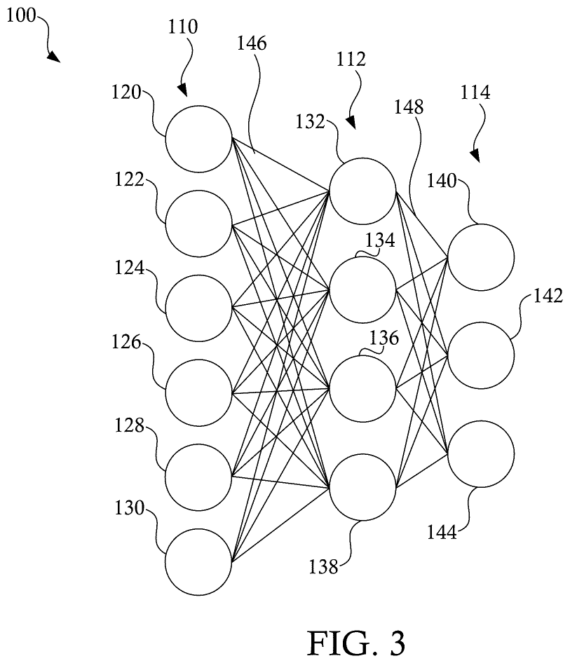

FIG. 3 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 can be arranged in layers 110-114, wherein the layers can comprise an intrinsic order introduced by the edges 146-148 between the nodes 120-144. In particular, edges 146-148 can exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 can be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number can be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 can comprise a weight being a real number, in particular, the weight is a real number within the interval [−1, 1], within the interval [0, 1], or within any other suitable range. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 can be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 can be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ can be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and γⱼ⁽ⁿ⁺¹⁾ is the comparison training value for the j-th node of the output layer 114.

In some embodiments, the neural network 100 is configured, or trained, for anomaly detection or classification. The neural network 100 can be configured to receive data representative of an interaction and identify the data as either anomalous or benign. The neural network 100 can be configured to receive and/or extract features from the data representative of the interaction and/or generate additional features from the data representative of the interaction and provide the extracted/generated features as input to trained hidden layers for classification. In some embodiments, the classification of a set of data representative of an interaction is based on a percent likelihood of the interaction falling into the selected classification.

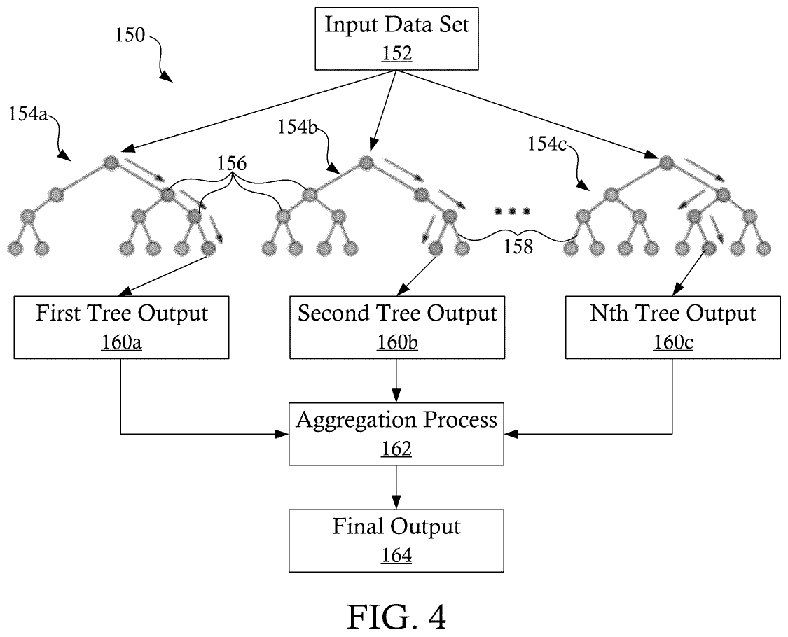

FIG. 4 illustrates a tree-based model 150, in accordance with some embodiments. In particular, the tree-based model 150 is a random forest neural network, though it will be appreciated that the discussion herein is applicable to other decision tree neural networks. The tree-based model 150 includes a plurality of trained decision trees 154a-154c each including a set of nodes 156 (also referred to as “leaves”) and a set of edges 158 (also referred to as “branches”).

Each of the trained decision trees 154a-154c can include a classification and/or a regression tree (CART). Classification trees include a tree model in which a target variable can take a discrete set of values, e.g., can be classified as one of a set of values. In classification trees, each leaf 156 represents class labels and each of the branches 158 represents conjunctions of features that connect the class labels. Regression trees include a tree model in which the target variable can take continuous values (e.g., a real number value).

In operation, an input data set 152 including one or more features or attributes is received. A subset of the input data set 152 is provided to each of the trained decision trees 154a-154c. The subset can include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based model 150 applies an aggregation process 162 to combine the output of each of the trained decision trees 154a-154c into a final output 164. For example, in embodiments including classification trees, the tree-based model 150 can apply a majority-voting process to identify a classification selected by the majority of the trained decision trees 154a-154c. As another example, in embodiments including regression trees, the tree-based model 150 can apply an average, mean, and/or other mathematical process to generate a composite output of the trained decision trees. The final output 164 is provided as an output of the tree-based model 150.

In some embodiments, the tree-based model 150 is configured, or trained, for anomaly detection or classification. The tree-based model 150 can be configured to receive data representative of an interaction and identify the data as either anomalous or benign. The tree-based model 150 can be configured to receive and/or extract features from the data representative of the interaction and/or generate additional features from the data representative of the interaction and provide the extracted/generated features as input to trained hidden layers for identification. In some embodiments, the classification of a set of data representative of an interaction is based on a percent likelihood of the interaction falling into the selected classification.

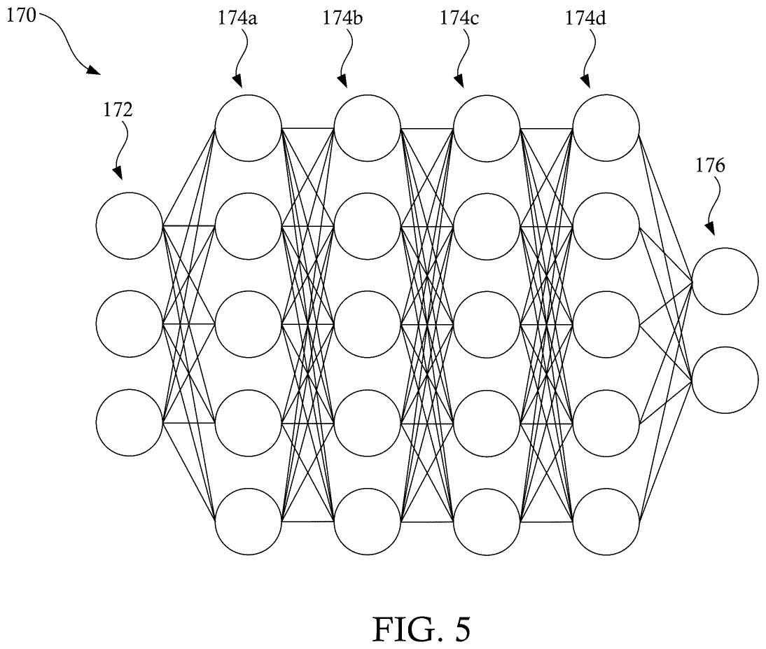

FIG. 5 illustrates a deep neural network (DNN) 170, in accordance with some embodiments. The DNN 170 is an artificial neural network, such as the neural network 100 illustrated in conjunction with FIG. 3, that includes representation learning. The DNN 170 can include an unbounded number of (e.g., two or more) intermediate layers 174a-174d each of a bounded size (e.g., having a predetermined number of nodes), providing for practical application and optimized implementation of a universal classifier. Each of the layers 174a-174d can be heterogenous. The DNN 170 can is configured to model complex, non-linear relationships. Intermediate layers, such as intermediate layer 174c, can provide compositions of features from lower layers, such as layers 174a, 174b, providing for modeling of complex data.

In some embodiments, the DNN 170 can be considered a stacked neural network including multiple layers each configured to execute one or more computations. The computation for a network with L hidden layers can be denoted as:

$$\\ f ( x ) = f [ {a}^{{}_{} ( L + 1 )} ( {h}^{{}_{} ( L )} ( {a}^{{}_{} ( L )} ( … ( {h}^{{}_{} ( 2 )} ( {a}^{{}_{} ( 2 )} ( {h}^{{}_{} ( 1 )} ( {a}^{{}_{} ( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) can include a linear operation with matrix W^{(l)} and bias b^{(l)}, where:

$$\\ {a}^{{}_{} ( l )} ( x ) = {W}^{{}_{} ( l )} x + {b}^{{}_{} ( l )}$$

In some embodiments, the DNN 170 is a feedforward network in which data flows from an input layer 172 to an output layer 176 without looping back through any layers. In some embodiments, the DNN 170 can include a backpropagation network in which the output of at least one hidden layer is provided, e.g., propagated, to a prior hidden layer. The DNN 170 can include any suitable neural network, such as a self-organizing neural network, a recurrent neural network, a convolutional neural network, a modular neural network, and/or any other suitable neural network.

In some embodiments, a DNN 170 can include a neural additive model (NAM). An NAM includes a linear combination of networks, each of which attends to (e.g., provides a calculation regarding) a single input feature. For example, an NAM can be represented as:

$$\\ y = β + {f}_{1} ( {x}_{1} ) + {f}_{2} ( {x}_{2} ) + … + {f}_{K} ( {x}_{K} )$$

where β is an offset and each fi is parametrized by a neural network. In some embodiments, the DNN 170 can include a neural multiplicative model (NMM), including a multiplicative form for the NAM mode using a log transformation of the dependent variable y and the independent variable x:

$$\\ y = {e}^{{}_{} β} {e}^{{}_{} f ( log x )} {e}^{{}_{} {\sum }_{i} {f}_{i}^{d} ( {d}_{i} )}$$

where d represents one or more features of the independent variable x.

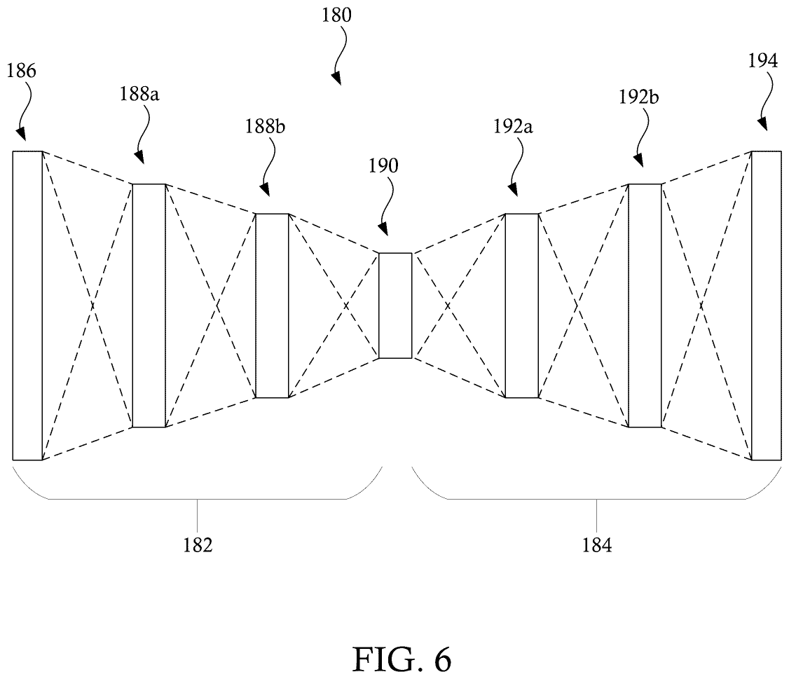

FIG. 6 illustrates an autoencoder 180, in accordance with some embodiments. An autoencoder 180 is configured to generated efficient coding 190 of unlabeled data. An encoding portion 182 is configured to receive an input 186 and generate a code 190 via a plurality of hidden layers 188a-188b. The code 190 is validated by a decoding portion 184 configured to regenerate an output 194 from the code 190 via a plurality of hidden layers 192a-192b. The code 190 includes a representation, such as a vector representation, for the input 186 and can be generated by, for example, dimensionality reduction.

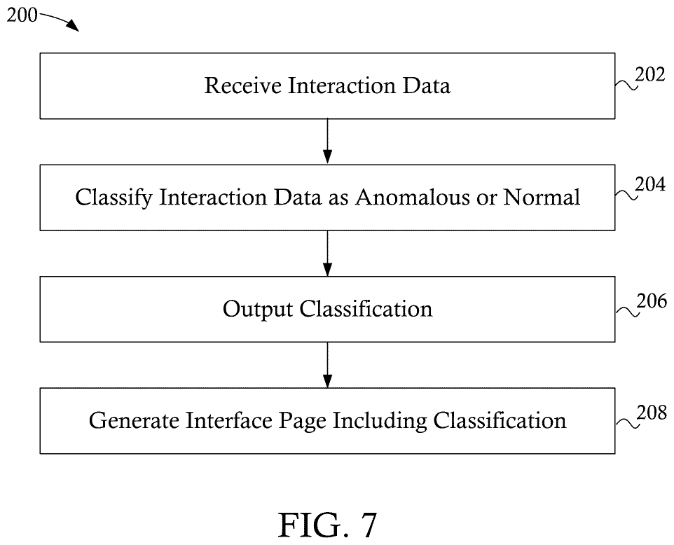

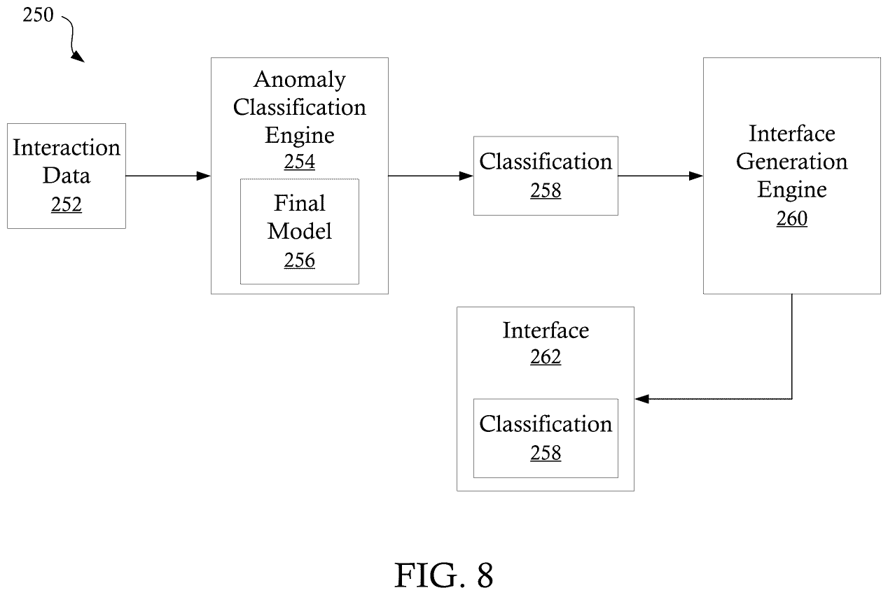

FIG. 7 illustrates a method 200 of classifying an interaction using a trained anomaly classification model, in accordance with some embodiments. FIG. 8 illustrates a process flow 250 of various portions of the method 200 of classifying an interaction, in accordance with some embodiments. At step 202, interaction data 252 is received. The interaction data 252 includes data representative of an interaction between two or more systems, a user and a system, an offline interaction, and/or any other suitable interaction. The interaction data 252 can include individual data elements representative of portions of an interaction. For example, in embodiments including a retail interaction, the interaction data 252 can include data elements representative of a return amount, a return quantity, a receipt return amount, a nonreceipt return amount, a channel identifier (e.g., store, website, etc.), a timestamp, and/or other retail interaction related data. Although embodiments are discussed herein including retail interactions, it will be appreciated that the interaction data 252 can be configured to store any data representative of any suitable interaction for classification by the method 200.

At step 204, the interaction data 252 is classified as anomalous or normal (e.g., benign or non-anomalous). In some embodiments, an anomaly classification engine 254 is configured to receive the interaction data 252 and classify the interaction data 252 by applying a trained anomaly classification model 256 to one or more of the data features, e.g., individual data elements, included in the interaction data 252. The trained anomaly classification model 256 can include any suitable trained classification model generated by a supervised learning process, as discussed in greater detail below. For example, the trained anomaly classification model 256 can include a logistic model, a tree-based model, a deep learning model, and/or any other suitable model generated by a supervised training process.

The trained anomaly classification model 256 can configured to receive the interaction data 252 and extract a relevant set of features for input to the one or more layers of the anomaly classification model 256 and/or can be configured to receive pre-extracted and/or generated features that are included in and/or derived from the interaction data 252. The set of input features can include all of or a subset of the features included in the interaction data 252.

In some embodiments, the trained anomaly classification model 256 includes a trained classification model generated by a supervised, or semi-supervised, training process, as discussed in greater detail below. In some embodiments, the trained anomaly classification model 256 is trained using a training dataset including labelled data generated, at least in part, by an ensemble anomaly detection model as discussed in greater detail below. In some embodiments, a labelled training data set includes both an initial label and a second label generated by an ensemble anomaly detection model.

At step 206, the classification 258 generated by the anomaly classification model 256 is output. The classification 258 can be stored in a data store, such as, for example, a database, can be transmitted to one or more additional systems for further processing, and/or can be displayed to a user via one or more display mechanism. For example, at optional step 208, the classification 258 is provided to an interface generation engine 260 configured to generate or modify an interface page 262, such as network or local interface page, based on the classification 258. In some embodiments, the interface generation engine 260 can be configured to integrate the classification 258 into a suitable interface page. For example, in various embodiments, the interface page can include an interaction interface page related to the interaction represented by the interaction data 252, a review interface page configured to allow for review of prior interactions, a point-of-sale interface page configured to be displayed within a point-of-sale system such as systems installed at retail locations and/or provided through a website, and/or any other suitable interface page. In some embodiments, the interface generation engine 260 can be configured to modify an existing interface page to remove or disable certain interface elements based on the classification 258.

The task of identifying an anomalous interaction in real time (e.g., identifying the interaction as anomalous as the interaction occurs) can be burdensome and time consuming, extending periods of interaction beyond those necessary for the initial interaction to be completed. Where interactions include an element of exchange, e.g., retail transactions, return transactions, monetary transfers, etc., the timeframe for those interactions is measured in minutes with several steps needing to be performed in order to complete the interaction. Typically, identification of anomalous interactions cannot be performed within the limited time frame available to interactions of interest and is limited by available resources, which are often devoted to processing the interaction itself and cannot be used for anomaly detection.

Systems and methods of anomaly classification, including interfaces configured to display the results of an anomaly classification, as disclosed herein, significantly reduce this problem. For example, in embodiments disclosed herein, when an interaction is classified as anomalous, an interface page can be modified or converted to prevent completion of the interaction and to inform individuals related to the interaction that the interaction is anomalous. Each classification 258 thus serves as a programmatically selected interface aid that activates or disables certain interface functions based on the classification 258. Beneficially, programmatically enabling or disabling interface functions can improve the speed and accuracy of a user's navigation through an interface in order to complete a transaction. For example, a user can continue entering information related to an interaction or performing additional steps of an interaction through an interface unless and until a classification indicates an anomalous interaction. This can be particularly beneficial for computing devices with limited screen sizes, as the limited screen space can be provided for continuing an interaction and an indication of an anomalous interaction can be provided simply by disabling one or more of the limited interface elements on the screen.

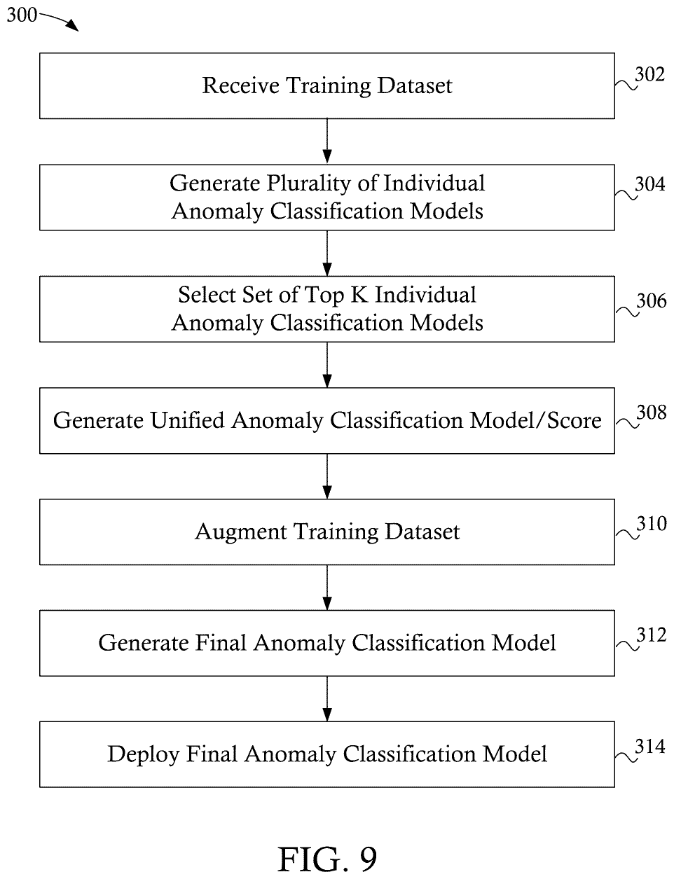

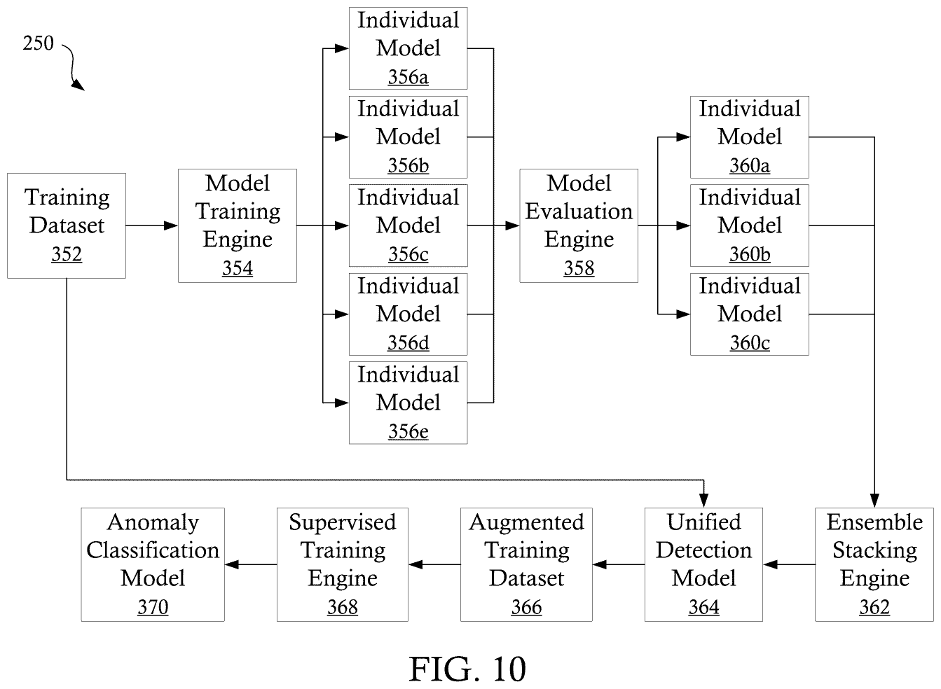

FIG. 9 illustrates a method 300 of generating a trained anomaly detection model, in accordance with some embodiments. FIG. 10 illustrates a process flow 350 including various steps of the method 300 of generating a trained anomaly detection model, in accordance with some embodiments. At step 302, a training dataset 352 is received. The training dataset 352 includes a set of interactions E:

$$\\ E = ( {e}_{1} , {e}_{2} , … , {e}_{n} )$$

where each interaction e; is an n-dimensional vector:

$$\\ {e}_{i} = [ {x}_{i , 1} , {x}_{i , 2} , {x}_{i , 3} , … , {x}_{i , n - 1} , {x}_{i , n} ]$$

where xᵢ represents a feature for the interaction eᵢ. For example, in embodiments including retail interactions, the set of interactions includes a interactions having n-dimensional vectors including a return amount, a return quantity, a receipt return amount, a nonreceipt return amount, a store identifier, a timestamp, and/or any other suitable features. Although specific embodiments are discussed herein including a retail interaction, it will be appreciated that the set of interactions can include any suitable interactions having any suitable set of features.

In some embodiments, a subset of the interactions et include a preliminary label indicating whether the interaction is preliminarily classified as a benign interaction or an anomalous interaction. The preliminary classification can be applied based on one or more existing classification models, manually applied, and/or based on any suitable classification process.

At step 304, a plurality of individual anomaly detection models 356a-356e are generated. The individual anomaly detection models 356a-356e can be trained by one or more model training engines 354, each configured to receive the training dataset 352 (or a subset of the training dataset 352). For example, in some embodiments, a subset of the training dataset 352 including only benign interactions is provided for training. The plurality of individual anomaly detection models 356a-356e can be represented as:

$$\\ M = \{ {M}_{j} \} = \{ {M}_{1} , {M}_{2} , … , {M}_{l} \}$$

where Mⱼ is the j^{th} individual anomaly detection model. Each of the individual anomaly detection models 356a-356e can be based on a different framework, such as, for example, Gaussian-based models, isolation forest models, autoencoders, deep network models, etc.

In some embodiments, a subset of features are selected for each interaction within the training dataset 352. For example, in some embodiments, a predetermined set of input features are defined for training a model and only those features are selected from the training dataset 352. The predetermined set of features can be different for each model being trained by a model training engine 354. In some embodiments, all of the features in the training dataset 352 are provided for training and a subset of relevant features are identified by the training process.

Each of the plurality of individual anomaly detection models 356a-356e are generated by applying an iterative training process to at least a portion of the training dataset 352. For example, in some embodiments, the training dataset 352 can be divided into subsets including a training subset, a testing subset, and a verification subset. The iterative training processes applied to generate each of the plurality of individual anomaly detection models 356a-356e can be limited to only the training subset and/or the training subset and the testing subset. Alternatively, in some embodiments, a subset of features included in each n-dimensional vector is selected for use in an iterative training process and the training dataset 352 is filtered or truncated to include only the selected subset of features. It will be appreciated that any suitable filtering can be applied to limit the training dataset 352 and/or to limit the portions of the training dataset 352 used in an iterative training process.

In some embodiments, each model training engine 354 is configured to apply an unsupervised training process to generate one or more of the individual anomaly detection models 356a-356e. The unsupervised training process is configured to classify each interaction eᵢ within the set of interactions E into predetermined categories, such as, for example, anomalous and benign (e.g., non-anomalous) transactions. The unsupervised training process is configured to identify features within each n-dimensional vector that are significant with respect to the ranking and apply weightings at various hidden layers to generate a classification probability for an interaction eᵢ.

In some embodiments, each of the plurality of individual anomaly detection models 356a-356e are generated based on a different underlying framework. For example, one or more individual anomaly classification models 356a-356e can include a Gaussian-based model in which each feature in the portion of the training dataset 352 selected for training is linear and independent from one another such that probabilities of the model can be decomposed as:

$$\\ P ( X ) = P ( {x}_{1} ) * P ( {x}_{2} ) * … * P ( {x}_{n} )$$

In some embodiments, the subset of the training dataset 352 provided for training of a Gaussian-based model includes data generated from a Gaussian distribution. As another example, one or more of the individual anomaly detection model 356a-356e can include an isolation forest model in which a tree partition produces noticeably shorter paths for anomalous interactions as the fewer instances of anomalies within the training dataset 352 result in a smaller number of partitions within the isolation forest structure (e.g., shorter paths in the tree structure) and interactions with distinguishable attribute-values (e.g., anomalous interactions) are more likely to be separated early in partitioning. As yet another example, one or more of the individual anomaly detection models 356a-356e can include an autoencoder in which the iterative training process identifies a plurality of hidden layers that provide an internal representation of a benign event and therefore provide low reconstruction (e.g., poor decoding) when asked to replicate anomalous events. Although example individual anomaly detection models 356a-356e are discussed herein, it will be appreciated that any number of individual anomaly detection models 356a-356e based on any suitable machine learning framework can be generated by the model training engine 354.

In some embodiments, each model training engine 354 is configured to apply suitable machine learning processes to select and prepare data for training of an individual anomaly detection model 356a-356e. For example, a model training engine can be configured to apply sampling, feature selection, dimension reduction, regularization, and/or other processes to the training dataset 352 (or a subset of the training dataset 352) prior to and/or simultaneous with applying an iterative training process to generate an individual anomaly detection model 356a-356e. It will be appreciated that the pre-processing and/or processing requirements can be determined, in part, based on the model framework selected for training an individual anomaly detection model 356a-356e.

At step 306, a set of the top K individual anomaly detection models 360a-360c is selected from the set each of the generated individual anomaly detection models 356a-356e. For example, in some embodiments an evaluation engine 358 is configured to evaluate each of the generated individual anomaly detection models 356a-356e using a uniform evaluation process. For example, an evaluation engine 358 can be configured to apply a uniform evaluation method V and generate evaluation metrics for each of the generated individual anomaly detection models 356a-356e V={Vⱼ}, where Vⱼ is an evaluation metric for a model j. The evaluation engine 358 can be further configured to rank the individual anomaly detection models 356a-356e and select the K top ranked individual anomaly detection models 360a-360c, where K is an integer greater than 1. The top ranked individual anomaly detection models 360a-360c can include the individual anomaly detection models 356a-356e having the highest evaluation metric, the lowest evaluation metric, or an evaluation metric close to a predetermined value, such as a mean, average, etc., depending on the relationship between the evaluation metric selected and performance of the model.

The uniform evaluation method V can include any suitable evaluation process, such as, for example, an area under the curve (AUC) score, precision, recall, F score, and/or any other suitable evaluation metric. For example, in some embodiments, the uniform evaluation process utilizes a weighted harmonic mean of precision and recall, e.g., an F_{β} score. The F_{β} can be determined as:

$$\\ {F}_{β} = ( 1 + {β}^{{}_{} 2} ) \frac{P * R}{{β}^{{}_{} 2} * P + R}$$

$$\\ P = \frac{{T}_{p}}{{T}_{p} + {F}_{p}}$$

$$\\ R = \frac{{T}_{p}}{{T}_{p} + {F}_{N}}$$

where β is a harmonic mean control coefficient, P is precision of an individual anomaly classification model, R is recall of the individual anomaly detection model, Tₚ is a true positive identification rate, Fₚ is a false positive identification rate, and F_{N} is a false negative identification rate. It will be appreciated that the type of classification identified as positive or negative can depend on the training of the underlying model. For example, a model trained to positively identify benign interactions will have a “true positive” when a benign interaction is identified as a benign interaction and a true negative when an anomalous interaction is classified as a non-benign interaction. Conversely, a model that is trained to positively identify anomalous interactions will have a “true positive” when an anomalous interaction is identified as an anomalous interaction and a true negative when a benign interaction is classified as a non-anomalous interaction In some embodiments, the uniform evaluation process utilizes an F₂ score (e.g., β=2):

$$\\ {F}_{2} = ( 1 + {2}^{{}_{} 2} ) \frac{P * R}{{2}^{{}_{} 2} * P + R}$$

$$\\ {F}_{2} = ( 5 ) \frac{P * R}{4 P + R}$$

At step 308, a unified anomaly detection model 364 is generated. The unified anomaly detection model 364 can be generated by an ensemble stacking engine 362 configured to combine the top K ranked individual anomaly detection models 360a-360c, for example, by combining output anomaly scores for each of the top K ranked individual anomaly detection models 360a-360c. For example, in some embodiments, each of the top K ranked individual detection models 360a-360c is configured to generate an anomaly score sⱼ. A unified anomaly score s can be generated, where:

$$\\ s = \{ {s}_{1} , {s}_{2} , … , {s}_{l} \}$$

based on the anomaly score sⱼ of each of the top K ranked individual anomaly classification models 360a-360c. In some embodiment, each of the individual anomaly scores sⱼ include a positive score. The unified anomaly score can be any suitable combined score, such as, a probability, loss, error, etc.

In some embodiments, a unified anomaly score s is generated based on a skewness of each of the top K ranked individual anomaly classification models 360a-360c. For example, a skewness μ=μⱼ for each sⱼ can be determined by:

$$\\ {μ}_{j} = \frac{\frac{1}{N} {\sum }_{i = 1}^{N} {( {S}_{i , j} - \overline{{S}_{j}} )}^{3}}{{( \frac{1}{N} {\sum }_{i = 1}^{N} {( {S}_{i , j} - \overline{{S}_{j}} )}^{2} )}^{3 / 2}}$$

where S_{i,j} is an anomaly score for each interaction i based on individual anomaly classification model j. A log transform of Sⱼ can be determined for |μ|>a, where a is a threshold value, and a normalized anomaly score Z={Zᵢ}, where:

$$\\ {Z}_{i} = \frac{{S}_{j} - min ( {S}_{j} )}{max ( {S}_{j} ) - min ( {S}_{j} )}$$

A unified anomaly score U can then be determined according to:

$$\\ U = {\sum }_{j = 1}^{l} {w}_{j} {Z}_{j}$$

where weight wⱼ is defined as:

$$\\ {w}_{j} = \frac{{V}_{j}}{{\sum }_{j = 1}^{l} {V}_{j}} and where :$$

$$\\ {V}_{i} = \{ \begin{matrix}{V}_{i} , & if i is one of the top K models \\ 0 , & if i is not one of the top K models\end{matrix}$$

At step 310, the training dataset 352 can be augmented and/or modified based on the output of the unified anomaly detection model 364, e.g., based on the uniform anomaly score, to generate an augmented training dataset 366. For example, in some embodiments, the unified anomaly detection score illustrates a probability that an interaction is anomalous and/or non-anomalous. Each interaction in the training dataset 352 can be processed by the unified anomaly detection model 364 to generate a unified anomaly detection score and the interaction can be classified as anomalous or benign based on the unified anomaly detection score. The interaction can be labeled (or re-labeled if the training dataset 352 included a label for the selected interaction) based on the unified anomaly detection score. In some embodiments, an interaction can be flipped, e.g., an interaction originally classified as anomalous can be re-labeled as benign and/or an interaction classified as benign can be re-labeled as anomalous.

In some embodiments, an interaction is flipped only if the unified anomaly score is above and/or below a predetermined threshold. For example, in some embodiments, a high (e.g., above a first predetermined threshold) unified anomaly score can indicate a high likelihood that a selected interaction is an anomalous interaction and a low (e.g., below a second predetermined threshold) unified anomaly score can indicate a high likelihood that a selected interaction is a normal interaction. In some embodiments, if an interaction classified as normal has an anomaly detection score above the first predetermined threshold, the interaction is re-labelled as anomalous. Similarly, if an interaction classified as anomalous has an anomaly detection score below the second predetermine threshold, the interaction is re-labelled as normal. The first and second predetermined thresholds can be the same value and/or different values.

In some embodiments, a cut-off threshold C for re-classification is determined based an evaluation metric. The evaluation metric can include the same evaluation metric used at step 306 and/or be a different evaluation metric. For example, in some embodiments, a cut-off threshold C is selected based on an F₂ score, a gains chart, and/or any other suitable metric. The cut-off threshold C can include a point at which the F₂ score, a precision curve, and a recall curve each intersect.

In some embodiments, only interactions misclassified into a selected category are reclassified based on the anomaly detection score. For example, in some embodiments, interactions initially labelled as normal interactions but classified as anomalous based on the unified anomaly score can be eligible for reclassification (as discussed above) while interactions initially labelled as anomalous but classified as normal based on the unified anomaly score can be ineligible for reclassification. It will be appreciated that any suitable criteria can be used for reclassification based on the unified anomaly score.

At step 312, an anomaly classification model 370 is generated by applying a supervised training process based on the augmented training dataset 366. For example, in some embodiments, a supervised model training engine 368 applies a supervised learning process to a selected model to iteratively train an anomaly classification model 370. The selected model can include any suitable supervised learning framework, such as, for example, a logistic model, a tree-based model, a deep learning model, and/or any other suitable model.

At step 314, the anomaly classification model 370 can be deployed for real-time anomaly detection, as discussed above with respect to FIGS. 7-8. The augmented training dataset 366 provides a more robust and complete training dataset for generating the anomaly classification model 370, providing a more accurate classification of real-time interactions by the anomaly classification model 370. Training based on the augmented training dataset 366 configures the anomaly classification model 370 to detect different types of anomalies, such as, for example, point, contextual, and/or collective anomalies.

The disclosed method 300 improves operation of systems, such as computer systems described in conjunction with FIG. 1, when performing operations related to generating and deploying trained machine learning models. In particular, the disclosed method 300 provides for improvements in the generation of trained machine learning models by providing augmented training datasets for use in supervised training. The augmented training datasets reduce time for training, allow for better verification and testing of generated models, and increase the accuracy of generated models, without the need for additional data input or collection. Further, by generating final anomaly classification models, the disclosed method 300 improves the performance of a computing device when performing anomaly classification and detection in various fields, such as, for example, fraud detection within e-commerce or retail environments.

The disclosed method 300, and the final anomaly classification models 370 generated using the method 300, provide a flexible, systematic, end-to-end anomaly detection architecture that provides augmentation of existing datasets and detection of anomalies at low cost (e.g., lower computing resources, time, etc.) compared to traditional architectures. The disclosed architecture also allows for detection of different types of anomalies simultaneously, without the need to train or additional models for each type of anomaly. The disclosed architecture allows for plug-and-play anomaly detection by training various underlying individual anomaly detection models and applying an ensemble stacking process to detect both existing and emerging anomalies.

Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory;
a processor communicatively coupled to the non-transitory memory, wherein the processor is configured to read a set of instructions to:
obtain, from the non-transitory memory, a training dataset including data representative of a plurality of interactions;
generate a plurality of anomaly detection models, wherein at least one of the plurality of anomaly detection models is generated by an unsupervised training process;
generate a unified anomaly score by combining outputs of a subset of the plurality of anomaly detection models;
generate an augmented training dataset by labeling at least one of the interactions in the plurality of interactions based on the unified anomaly score; and
generate an anomaly classification model by applying a supervised training process including the augmented training dataset.

2. The system of claim 1, wherein the subset of plurality of anomaly detection models comprises a set of top ranked individual anomaly detection models selected from the plurality of anomaly detection models.

3. The system of claim 2, wherein the processor is configured to read the set of instructions to:
generate an evaluation metric for each of the plurality of anomaly detection models by applying a uniform evaluation process; and
rank the plurality of anomaly detection models based on the evaluation metric, wherein the set of top ranked individual anomaly detection models includes the plurality of anomaly detection models having a highest rank based on the evaluation metric.

4. The system of claim 1, wherein the outputs of the subset of the plurality of anomaly detection models are combined based on a skewness of each of the outputs.

5. The system of claim 1, wherein the at least one of the interactions in the plurality of interactions includes an original label, and wherein the at least one of the interactions is relabeled in the augmented training dataset to have a label other than the original label.

6. The system of claim 5, wherein the at least one of the interactions has an evaluation metric above a cutoff threshold.

7. The system of claim 5, wherein the original label comprises a label in a first category, and wherein the label other than the original label comprises a label in a second category.

8. A computer-implemented method, comprising:
obtaining a training dataset including data representative of a plurality of interactions;
generating a plurality of anomaly detection models, wherein at least one of the plurality of anomaly detection models is generated by an unsupervised training process;
generating a unified anomaly score by combining outputs of a subset of the plurality of anomaly detection models;
generating an augmented training dataset by labeling at least one of the interactions in the plurality of interactions based on the unified anomaly score; and
generating an anomaly classification model by applying a supervised training process including the augmented training dataset.

9. The computer-implemented method of claim 8, wherein the subset of plurality of anomaly detection models comprises a set of top ranked individual anomaly detection models selected from the plurality of anomaly detection models.

10. The computer-implemented method of claim 9, comprising:
generating an evaluation metric for each of the plurality of anomaly detection models by applying a uniform evaluation process; and
ranking the plurality of anomaly detection models based on the evaluation metric, wherein the set of top ranked individual anomaly detection models includes the plurality of anomaly detection models having a highest rank based on the evaluation metric.

11. The computer-implemented method of claim 8, wherein the outputs of the subset of the plurality of anomaly detection models are combined based on a skewness of each of the outputs.

12. The computer-implemented method of claim 8, wherein the at least one of the interactions in the plurality of interactions includes an original label, and wherein the at least one of the interactions is relabeled in the augmented training dataset to have a label other than the original label.

13. The computer-implemented method of claim 12, wherein the at least one of the interactions has an evaluation metric above a cutoff threshold.

14. The computer-implemented method of claim 12, wherein the original label comprises a label in a first category, and wherein the label other than the original label comprises a label in a second category.

15. A non-transitory computer readable medium having instructions stored thereon that, when executed by one or more processors, cause one or more devices to perform operations comprising:
generating a plurality of anomaly detection models, wherein at least one of the plurality of anomaly detection models is generated by an unsupervised training process;
generating a unified anomaly score by combining outputs of a subset of the plurality of anomaly detection models;
generating an augmented training dataset by labeling at least one of the interactions in the plurality of interactions based on the unified anomaly score; and
generating an anomaly classification model by applying a supervised training process including the augmented training dataset.

16. The non-transitory computer readable medium of claim 15, wherein the subset of plurality of anomaly detection models comprises a set of top ranked individual anomaly detection models selected from the plurality of anomaly detection models.

17. The non-transitory computer readable medium of claim 15, wherein the instructions cause the one or more devices to perform operations comprising:
generating an evaluation metric for each of the plurality of anomaly detection models by applying a uniform evaluation process; and
ranking the plurality of anomaly detection models based on the evaluation metric, wherein the set of top ranked individual anomaly detection models includes the plurality of anomaly detection models having a highest rank based on the evaluation metric.

18. The non-transitory computer readable medium of claim 15, wherein the outputs of the subset of the plurality of anomaly detection models are combined based on a skewness of each of the outputs.

19. The non-transitory computer readable medium of claim 15, wherein the at least one of the interactions in the plurality of interactions includes an original label, and wherein the at least one of the interactions is relabeled in the augmented training dataset to have a label other than the original label.

20. The non-transitory computer readable medium of claim 15, wherein the at least one of the interactions has an evaluation metric above a cutoff threshold, wherein the original label comprises a label in a first category, and wherein the label other than the original label comprises a label in a second category.
